(19) United States
(12) Patent Application Publication
(10) Pub. No.: US 2024/0060629 A1
(43) Pub. Date: Feb. 22, 2024

(54) LIGHT APPLICATION DEVICE

(71) Applicant: SCHOTT AG, Mainz (DE)

(72) Inventor: Bernd Wölfing, Mainz (DE)

(73) Assignee: SCHOTT AG, Mainz (DE)

(21) Appl. No.: 18/451,217

(22) Filed: Aug. 17, 2023

(30) Foreign Application Priority Data
Aug. 22, 2022 (DE) 10 2022 121 128.2

(51) Int. Cl. F21V 21/14; F21V 21/108; F21V 3/06; F21V 23/02; F21V 7/00

(52) U.S. Cl. CPC F21V 21/145; F21V 21/108; F21V 3/061; F21V 23/023; F21V 7/0075; F21W 2131/202

(57) ABSTRACT

A light application device for curing of liquid materials is provided. The device includes a handpiece and a light guiding element which can be mounted to the handpiece and has a light guiding body consisting of a solid body. The light guiding element defines a first optical axis for coupled-in light and a second optical axis for coupled-out light. The second optical axis runs transversely to the first optical axis. The light guiding element has a distal end side at which the coupled-in light can be deflected for coupling out in such a way that the light exit is formed by a region of the lateral surface of the light guiding element. The distal end side has end faces for deflecting the light. The end faces each extend transversely to the first optical axis and transversely to the second optical axis and are connected to one another via intermediate surfaces.

### CROSS REFERENCE TO RELATED APPLICATIONS

This application claims benefit under 35 USC § 119 of German Application 10 2022 121 128.2 filed Aug. 22, 2022, the entire contents of which are incorporated herein by reference.

### BACKGROUND

### 1. Field of the Invention

The invention relates to a light application device, in particular for light curing of liquid materials, comprising a handpiece and a light guiding element which can be mounted to the handpiece and has a light guiding body consisting of a solid body.

### 2. Description of Related Art

Light-curable materials are used in the field of dentistry inter alia, e.g., for sealing or filling teeth or as adhesives. Such light-curable materials are initially soft or liquid so that they can be attached to or shaped against the tooth and cure by irradiation with light at a specific wavelength.

Light application equipment is used to irradiate the light-curable material. Due to the limited space in the oral cavity and in order to enable sterilization between patients, this equipment usually has a light guiding element which is guided into the oral cavity and to the light-curable material and which is connected outside the oral cavity to a light source, which can be housed in a handpiece, for example.

The light guiding element inserted into the oral cavity is typically curved or angled at the front end so that the light can also be directed to places which are difficult to access.

Corresponding light curing devices and light guiding elements are known for instance from U.S. Pat. No. 5,147,204, EP 2 339 382 A1, US 2008/0254405 A1, US 2006/0040231 A1, U.S. Pat. No. 6,749,427 B1, FR 2 334 785 A1 or DE 26 03 513 A1.

### SUMMARY

The present invention is based on the object of providing a light application device and a light guiding element which can also be optimally used in places in the oral cavity which are difficult to access and at the same time enables optimized efficiency. Further aspects of the object of the invention are to enable the lightest possible weight, the best possible adaptation to the shape of the tooth, and hardness reduction in the event of unintentional contact with the tooth.

According to the invention, a light application device, in particular for light curing of liquid materials, e.g., dental fillings within the oral cavity, is provided. The device comprises a handpiece and a light guiding element which can be mounted, in particular detachably, to the handpiece.

The handpiece comprises a housing and a light source which is arranged inside the housing and serves to emit light.

The light guiding element comprises a light guiding body consisting of a solid body. Furthermore, the light guiding element comprises a light entrance for coupling light into the light guiding body and a light exit for coupling light out of the light guiding body. The light is thus coupled into a transparent solid body, guided through this transparent solid body and coupled out of this transparent solid body again.

The light guiding element and/or the light guiding body has a longitudinal extent and defines a first optical axis for light coupled into the light guiding body, this first optical axis running along said longitudinal extent. Furthermore, the light guiding element and/or the light guiding body defines a second optical axis for light coupled out of the light guiding body, wherein the second optical axis runs transversely, i.e., not parallel, to the first optical axis. Accordingly, the light guiding element is designed in such a way that light is coupled out obliquely and/or laterally to the first optical axis.

At a distal end of its longitudinal extent, the light guiding element has a distal end side at which the light coupled into the light guiding body can be deflected for coupling out, in such a way that the light exit is formed by a region of the lateral surface of the light guiding element and/or of the light guiding body. The lateral surface of the light guiding element and/or of the light guiding body corresponds in particular to the surface which extends around the longitudinal axis, while the proximal and distal ends in particular each form an end side.

The distal end side has a plurality of end faces for deflecting the light, which each extend transversely, i.e., not parallel, to the first optical axis and transversely, i.e., not parallel, to the second optical axis and which are connected to one another via intermediate surfaces.

The light guiding element and/or the light guiding body have in particular the shape of a rod with a rod axis which runs along the longitudinal extent, which in particular runs essentially substantially rectilinearly. In other words, the light guiding element and/or the light guiding body is substantially uncurved.

The optical axis of the coupled-out light (the second optical axis) thus also runs transversely to the longitudinal extent and/or the rod axis of the light guiding element, in particular transversely to the longitudinal extent and/or rod axis in the distal region or at the distal end. In other words, the light is coupled out laterally.

The light guiding element and/or the light guiding body have a proximal end face, in particular at a proximal end of the longitudinal extent, wherein this proximal end face preferably forms the light entrance. In addition to a flat design of the proximal end face, it can also be curved, e.g., concave or convex towards the light source, in order to adapt or optimize the coupling in of the light to the light source.

As described, the light guiding element and/or the light guiding body is preferably straight or uncurved. Accordingly, the proximal and distal end sides are opposite each other, in particular on a straight line.

As described, the distal end side has a plurality of end faces for deflecting or coupling out the light, which are connected via intermediate surfaces. These end faces, which are connected to one another by the intermediate surfaces, are preferably arranged offset in the direction of the longitudinal extent and/or the rod axis of the light guiding element and/or the light guiding body. In particular, the end faces are thereby fanned out along the longitudinal extent and/or thereby extend along the longitudinal extent over a larger area. Furthermore, these end faces connected to one another by the intermediate surfaces are preferably also arranged offset transversely, in particular perpendicularly, to the longitudinal extent and/or the rod axis of the light guiding element. In other words, the end faces and intermediate surfaces form a step-like arrangement, especially due to their alternating sequence.

The light guiding element may be intended for the curing of dental fillings, for example. In this case, the usual tooth dimensions may have to be taken into account. Especially in this case, but also independently thereof, the dimension of the light exit along the longitudinal extent of the light guiding element may be in a range of 2 mm to 20 mm, preferably in a range of 5 mm to 15 mm, particularly preferably in a range of 3 mm to 8 mm. Alternatively or additionally, the thickness of the light guiding element perpendicular to the light exit, in particular at the distal end, may be in a range of 1 mm to 15 mm, preferably in a range of 2 mm to 10 mm, particularly preferably in a range of 3 mm to 8 mm.

In particular, the dimension of the light exit along the longitudinal extent of the light guiding element is greater than the thickness of the light guiding element perpendicular to the light exit by a factor of at least 1.5, preferably by a factor of at least 2, particularly preferably by a factor of at least 3.

In principle, it may be desirable within the scope of the invention to keep the thickness or height, in particular at the distal end, and/or the weight of the light guiding element as low as possible. Nevertheless, an additional terminal edge and/or terminal surface can be provided, if necessary, which increases the thickness or height, in particular at the distal end, and/or the weight of the light guiding element. In other words, the distal end is obtuse or has an obtuse termination.

In particular, the distal end face may have such a terminal surface at the outermost end. Preferably, the terminal surface may form an obtuse termination to the light guiding element at the outermost end of the distal end face. The terminal surface can, for example, be flat or rounded and extend in such a way that acute angles are avoided at the outermost end of the distal end face, in particular angles of less than 75 degrees are avoided. The terminal surface can preferably extend in such a way that a normal vector of the terminal surface forms a larger angle with the first optical axis than an angle between the normal vector of an end face and the first optical axis.

A terminal surface may preferably have a thickness fraction ranging from 3% to 30% of the thickness of the light guiding element. Although this is actually opposed to a reduction in thickness or height, in particular at the distal end, and/or the weight of the light guiding element, and although this may result in a loss of intensity of the emerging light, this can advantageously avoid or reduce the risk of injury, in particular in the field of medical applications. Furthermore, the additional thickness can have a homogenizing effect on the emerging light.

The terminal surface is formed in particular by the material of the light guiding body or the light guiding element. In other words, the terminal surface or the additional or increased thickness or height associated with it is monolithically formed with the light guiding body or the light guiding element, in particular at the distal end of the light guiding element.

The or some of the end faces of the end side are preferably planar. Furthermore, the or some of the end faces preferably have the same orientation.

The or some of the intermediate surfaces are preferably planar. Furthermore, the or some of the intermediate surfaces preferably have the same orientation.

The end faces of the distal end side preferably extend in such a way that a normal vector forms an angle with the first and/or second optical axis which is between 157.5 and 112.5 degrees, preferably between 145 and 125 degrees, particularly preferably between 140 and 130 degrees, more preferably between 137.5 and 132.5 degrees.

The second optical axis preferably runs at an angle to the first optical axis of between 45 and 135 degrees, preferably between 70 and 110 degrees, particularly preferably between 80 and 100 degrees, more preferably between 85 and 95 degrees.

The intermediate surfaces of the distal end side preferably extend such that a normal vector forms an angle with the first optical axis which is smaller than an angle between the normal vector of an end face and the first optical axis.

The intermediate surfaces of the distal end side preferably extend in such a way that a normal vector forms an angle with the first optical axis which is between 70 and 110 degrees, particularly preferably between 80 and 100 degrees, more preferably between 85 and 95 degrees.

In a preferred embodiment, it is provided that the distal end side has a number of end faces which is in the range of 5 to 20, preferably in the range of 6 to 15, particularly preferably in the range of 7 to 11.

In a preferred embodiment, it is provided that the distal end side has a number of end faces per millimetre along the longitudinal extent which is in the range of 0.5 to 2, preferably in the range of 0.6 to 1.5, particularly preferably in the range of 0.7 to 1.1.

The aforementioned numbers of end faces or numbers of end faces per longitudinal dimension are particularly advantageous for optimal efficiency as described in more detail below.

Preferably, the light guiding element comprises a reflector which is applied in particular to the distal end side and/or the end faces thereof and serves to couple out light from the light guiding body. The reflector is preferably designed as a mirror or interference mirror with one or more layers, which are preferably vapour-deposited and/or sputtered on. In particular, the reflector can be applied directly to the light guiding body, i.e., without another layer underneath.

For example, for light with a wavelength between 380 and 500 nanometres, the reflector can have a reflectivity of more than 90 percent, preferably of more than 95 percent, particularly preferably of more than 99 percent.

The material of the light guiding body is preferably homogeneous and/or isotropic. In particular, the light guiding body is thus preferably not designed as a fibre bundle, i.e., preferably not a fibre-based light guide. In other words, in particular no fibre-optic elements are provided, but as described in particular glass or plastic mouldings which can be coated and can have at least one reflector element.

The light guiding body is preferably monolithic or one-piece. In other words, the light guiding body preferably does not consist of a plurality or multiplicity of interconnected components, i.e., in particular not of interconnected individual glass fibres. The light guiding body can thus form the, in particular, only light guiding core of the light guiding element.

In one embodiment, the light guiding body consists of glass, in particular produced as a pressed glass part, preferably comprising borosilicate glass and/or optical crown glass. Borosilicate glass has in particular the advantages of high chemical resistance and good autoclave resistance.

In another embodiment, the light guiding body is produced from plastic, in particular as a plastic injection moulded part, preferably comprising polycarbonate (PC), polymethylmethacrylate (PMMA) and/or cycloolefin copolymers (COC). Due to their comparatively low temperature resistance, light guiding bodies with PMMA are suitable for single-use purposes in particular and are, for example, only EtOx-sterilized.

The light guiding body, in particular the distal end side, especially its end faces and intermediate surfaces, can be produced by means of laser cutting, preferably cut from glass by means of laser cutting, and particularly preferably polished afterwards. Polishing can be carried out both abrasively and chemically or physically by means of an appropriate etching process.

The light guiding element comprises a cladding partially or completely enclosing the light guiding body and/or the reflector, wherein the cladding has a refractive index which is less than a refractive index of the light guiding body and wherein the cladding is preferably formed as an SiO2 sputter layer, as a plastic layer or as a liquid silicone rubber coating. As described, the light guiding body is preferably homogeneous, isotropic and/or monolithic. Accordingly, in particular, the light guiding body may have a substantially homogeneous and/or isotropic refractive index. The cladding, which is optionally applied to the light guiding body, can also preferably have a homogeneous and/or isotropic refractive index. In other words, it can be provided that the light guiding body has only one refractive index and/or that a cladding, if present, has only one refractive index.

The difference between the refractive index of the light guiding body and the refractive index of the cladding is preferably less than or equal to 0.16, preferably less than or equal to 0.08.

The thickness of the cladding is preferably less than or equal to 100 μm, preferably less than or equal to 10 μm, preferably less than or equal to 5 μm.

The housing of the handpiece may comprise a mounting device and the light guiding element may comprise a mounting area for mounting the light guiding element to the housing of the handpiece, in such a way that light emitted by the light source is coupled into the light guiding body through the light entrance and is coupled out of the light guiding body outside the housing of the handpiece through the light exit.

The longitudinal extent of the light guiding element and/or the light guiding body is preferably between 1 and 30 centimetres, preferably between 5 and 15 centimetres, particularly preferably between 8 and 12 centimetres.

The light guiding element and/or the light guiding body preferably have a cross section along the longitudinal extent, the area of which is between 0.1 and 3 square centimetres, preferably between 0.3 and 2 square centimetres, particularly preferably between 0.5 and 1.5 square centimetres.

The light guiding element can have a variable cross section along the longitudinal extent, in particular along the rod axis, wherein the cross section of the light guiding element is, for example, angular, in particular rectangular or square, or else round, in particular circular, at the proximal end and is, for example, angular, in particular rectangular, at the distal end and wherein a shape transition region is provided between the proximal and the distal end.

The cross section of the light guiding element can be conical, especially at the proximal end, e.g., to facilitate the coupling-in of divergent light.

It may be provided that a voltage source for providing a voltage for operating the light source is arranged within the housing of the handpiece. The voltage source is preferably configured as a rechargeable energy storage device. Furthermore, the light application device may preferably comprise a charging station configured to charge the rechargeable energy storage device.

The invention further relates to a light guiding element, in particular for a light application device as described above.

The light guiding element has a longitudinal extent and defines a first optical axis for light coupled into the light guiding body, this first optical axis running along the longitudinal extent of the light guiding element. The light exit defines a second optical axis for light coupled out of the light guiding body, the second optical axis running transversely to the first optical axis.

At a distal end of its longitudinal extent, the light guiding element has a distal end side at which the light coupled into the light guiding body can be deflected for coupling out, in such a way that the light exit is formed by a region of the lateral surface of the light guiding element.

The distal end side has a plurality of end faces for deflecting the light, which end faces each extend transversely to the first optical axis and transversely to the second optical axis and which are connected to one another via intermediate surfaces.

The light guiding element may further comprise one or more features mentioned above in connection with the light application device.

The invention further relates to the use of a light guiding element for curing liquid materials, in particular for industrial adhesive curing.

The light application device according to the invention and/or the light guiding element according to the invention are also suitable for further medical examinations, therapies or treatments of, for example, various skin, mucous membrane or cancerous diseases or as a component in or on such devices or equipment for examination and/or therapy. These can be, for example, photodynamic therapy (PDT) or photoimmunotherapy (PIT) or, in general, such examinations, therapies or treatments in which a targeted or directed and homogeneous illumination or application of light is desired, required or necessary in a limited space.

Photodynamic therapy (PDT) is a minimally invasive therapy option that can be used in addition to other therapy options. PDT is understood to ne a procedure for treating tumours and other tissue changes (such as vascular neoplasms) with light in combination with a light-activated substance. At the start of the treatment, light-sensitive substances, so-called photosensitizers, which accumulate in or on the cancer cells are injected into the bloodstream of the patients intravenously. These natural photosubstances concentrate in the tumour cells and cause a strong sensitivity to light there. For this purpose, several cannulas (typically up to 8) are pricked into the tumour tissue during PDT treatment, into each of which a light guiding element is inserted. In PDT treatments, laser light, usually with wavelengths in the visible spectral range, for example green light with a wavelength of 532 nm or red light with a wavelength of 690 nm, is usually coupled into the light application device and/or the light guiding element and coupled out at its light exit, so that the tumour tissue, for example, is illuminated as uniformly as possible. In the process, aggressive oxygen radicals are formed in these tumour cells and selectively destroy the tumour cells. In contrast to the diseased cells, the healthy cells remain unaffected by this chemical reaction. The exact mechanism of action is described inter alia in “Photodynamic Therapy of Cancer”, Cancer Medicine, 2003.

A similar procedure is the photoimmunotherapy (PIT), in which an immune reaction is triggered in the presence of a photoactivatable drug and the cancer cells necrotize as a result.

Finally, the invention also relates to a method for producing a light guiding element, comprising the provision of a base body with a longitudinal extent, in particular made of glass, e.g., as a glass pressed part, or made of plastic, e.g., as a plastic injection moulded part, and machining of the distal end of the base body in such a way that a distal end side is formed with a plurality of end faces which are connected to one another via intermediate surfaces.

The machining of the distal end can effected, for example, by means of a laser process, e.g., laser cutting, in particular by means of a line focus. It is also conceivable to produce the distal end side and/or the end faces and intermediate surfaces by means of a forming or deformation process, e.g., a pressing process, or to mould them onto a base body made of glass or plastic. This can be advantageous in particular if there are a small number of steps formed by the end faces and intermediate surfaces or if the steps are arranged on a large end side, e.g., 5 steps per 10 mm, and/or if rounding of corners and edges on the end faces and intermediate surfaces is acceptable. If, on the other hand, a larger number of steps are arranged on a smaller area, e.g., 15 or more steps per 10 mm, laser processes, especially the above-mentioned laser cutting with line focus, advantageously offer the option of embodying sharp corners and edges. Such laser processes can be carried out with continuous, but also pulsed, especially ultra-short pulsed, laser radiation.

Likewise, typical processes from microstructuring technology such as wet and dry chemical etching processes can be used. However, the preparatory processes usually required for this, e.g., coating, lithography and the like, are often costly, both in terms of time and equipment, and may only be attractive with an appropriate cost/benefit ratio. Like in the case of microstructuring technologies, the costs/benefit ratio of abrasive processes—possible in principle—such as grinding, lapping and polishing, possibly also CNC-supported, or e.g., ultrasonic vibrating lapping (USSL) should be considered first.

By means of the laser methods with line focus, a first cut surface is formed for this purpose, in particular at the distal end of the base body, along a first direction running obliquely to the longitudinal extent of the base body, in order to form a distal end face, and then, along a second direction running more parallel to the longitudinal extent of the base body than the first direction, a second cut surface is formed in order to form an intermediate surface, and then, preferably along the first direction, a third cut surface is formed in order to form a further distal end face.

### BRIEF DESCRIPTION OF THE DRAWINGS

Exemplary embodiments of the invention are explained in more detail below on the basis of the figures. In the figures:

FIG. 1 shows a lateral sectional view of a light application device with a light guiding element;

FIG. 2 shows a lateral sectional view of the distal end of the light guiding element of FIG. 1;

FIG. 3 shows a lateral sectional view of a simulative test arrangement with a light guiding element and beam paths of light coupled into the light guiding element and out of the light guiding element and two detectors (at a distance of 1 mm and 10 mm) for determining the local irradiance of the coupled-out light;

FIG. 4 shows an enlarged section of FIG. 3;

FIG. 5 shows a lateral sectional view orthogonal to the illustration in FIG. 3;

FIGS. 6-7 show local irradiances at a distance of 1 mm and 10 mm from the light guiding element according to the two detectors in FIG. 3;

FIGS. 8-9 show illustration of irradiances (after smoothing taking into account light scattering) at a distance of 0 mm and 10 mm from the light guiding element according to the two detectors in FIG. 3;

FIG. 10 shows a diagram of the efficiency h=(I_min*A/E) plotted against the number of end faces for different working distances in the case of a square curing area;

FIG. 11 shows a diagram of the efficiency h=(I_min*A/E) plotted against the number of end faces for different working distances in the case of a circle diameter; and

FIG. 12 shows a lateral sectional view of the distal end of a light guiding element with an obtuse terminal surface.

### DETAILED DESCRIPTION

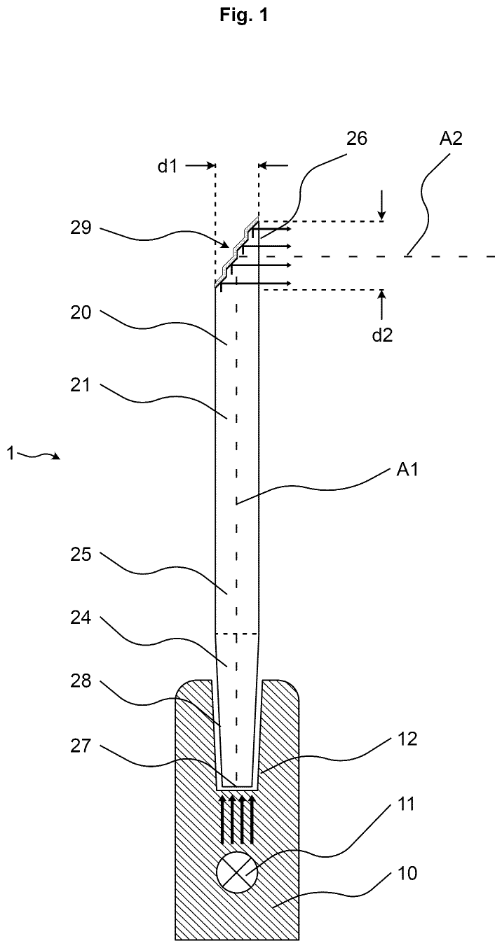

FIG. 1 shows a light application device 1 with a handpiece 10 in which a light source 11 is arranged and a light guiding element 20 which comprises a transparent light guiding body 21 or is designed as such. The handpiece 10 comprises a mounting device 12 for the light guiding element 20, and the light guiding element 20 comprises a corresponding mounting area 28 for mounting to the handpiece 10.

Light emitted by the light source 11 arranged in the handpiece can be coupled into the material of the light guiding body 21 through a light entrance 27 at the proximal end of the light guiding element 20 or of the light guiding body 21, and then coupled out laterally at the distal end by deflection at the distal end side 29 through a light exit 26 formed by the lateral surface of the light guiding element 20 or of the light guiding body 21.

In the example shown, the light guiding element 20 or the light guiding body 21 also has a cone section 24 to facilitate the coupling of divergent light in particular. In particular, light from LEDs, which is sometimes emitted at a relatively large angle, can as a result still be coupled into the light guiding body.

The light guiding element 20 is elongated and thus has a longitudinal extent and defines a first optical axis A1 parallel thereto for light coupled into the light guiding body. The light exit 26 formed by the lateral surface defines a second optical axis A2 for light coupled out of the light guiding body 21.

The second optical axis A2 thus runs transversely, in this case perpendicularly, to the first optical axis A1, without the light element 20 having a curvature at the distal end.

With a substantially straight light guiding element 20, which is designed to couple light out laterally, it is possible to provide a light guiding element with a flat structure. Only a small space requirement is associated with such a flat design, so that, for example, the curing of dental fillings is made possible, especially for molars (molar teeth).

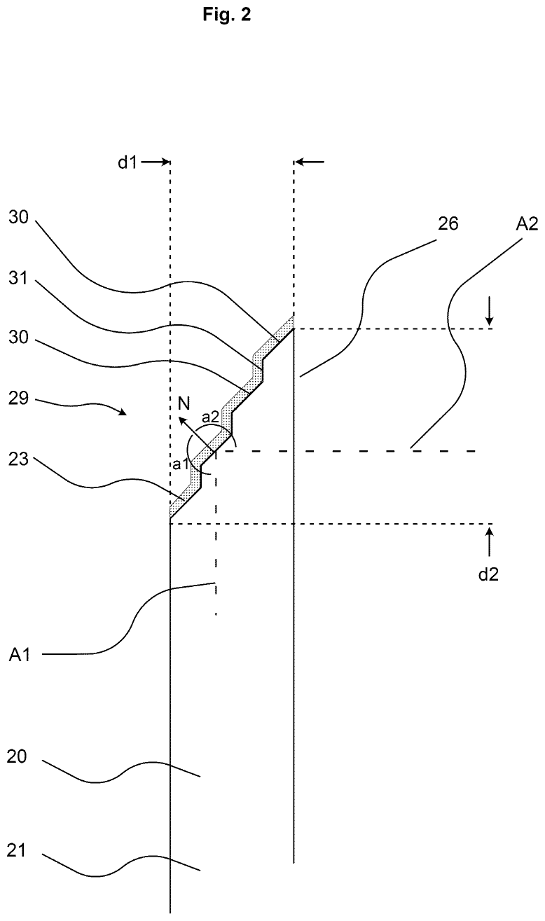

FIG. 2 shows an enlarged view of the distal end of the light guiding element 20.

It can be seen that the distal end side 29, which lies at the distal end of the rectilinear optical axis A1, has a plurality of end faces 30 for deflecting the coupled-in light. The end faces 30 each extend transversely to the first optical axis A1 and transversely to the second optical axis A2 and are thus suitable for deflecting the direction of the coupled-in light to the side.

In the example shown, the end faces 30 of the distal end side 29 extend in such a way that a normal vector N defining the end faces forms a respective angle a1 or a2 with both the first optical axis A1 and the second optical axis A2, which angle is between 125 and 145 degrees, in particular 135 degrees.

The end faces 30 thus extend in such a way that the normal vector N defining the end faces 30 has an angle a1 to the longitudinal extent of the light guiding element 20, in particular to the longitudinal axis or rod axis of the light guiding element 20, which is between 125 and 145 degrees, in particular 135 degrees.

The plurality of end faces 30 present are also connected to one another via intermediate surfaces 31. The intermediate surfaces 31 differ from the end faces 30 in particular in that they have a different orientation. In particular, the intermediate surfaces 31 extend in such a way that a normal vector defining the intermediate surface forms a smaller angle with the first optical axis A1 and/or with the longitudinal axis or rod axis of the light guiding element 20 than the aforementioned angle a1. In particular, the intermediate surfaces even extend parallel to the first optical axis A1 and/or the longitudinal axis or rod axis of the light guiding element 20, so that the angle between a normal vector defining the intermediate surface and the first optical axis A1 and/or the longitudinal axis or rod axis is 90 degrees.

The end faces 30 connected to one another by the intermediate surfaces 31 are arranged offset or staggered along the longitudinal extent of the light guiding element 20, in particular along the first optical axis A1.

This allows the dimension d2 of the light exit 26 along the longitudinal extent of the light guiding element 20 to be greater than the thickness d1 of the light guiding element 20 perpendicular to the light exit 26. In other words, a particularly flat light guiding element 20 can be realized, which moreover makes a low weight possible.

In addition to the light guiding body 21, the light guiding element 20 in the illustration also has a reflector 23 which is applied to the distal end side 29 in such a way that it covers both the end faces 30 and the intermediate surfaces 31. Such a reflector can comprise one or more layers, which can for example be vapour-deposited and/or sputtered onto the surface of the light guiding body 21.

Furthermore, in a development, the light guiding element 20 may also have an enclosing cladding layer (not shown), which encloses the light guiding body 21 together with the reflector 23.

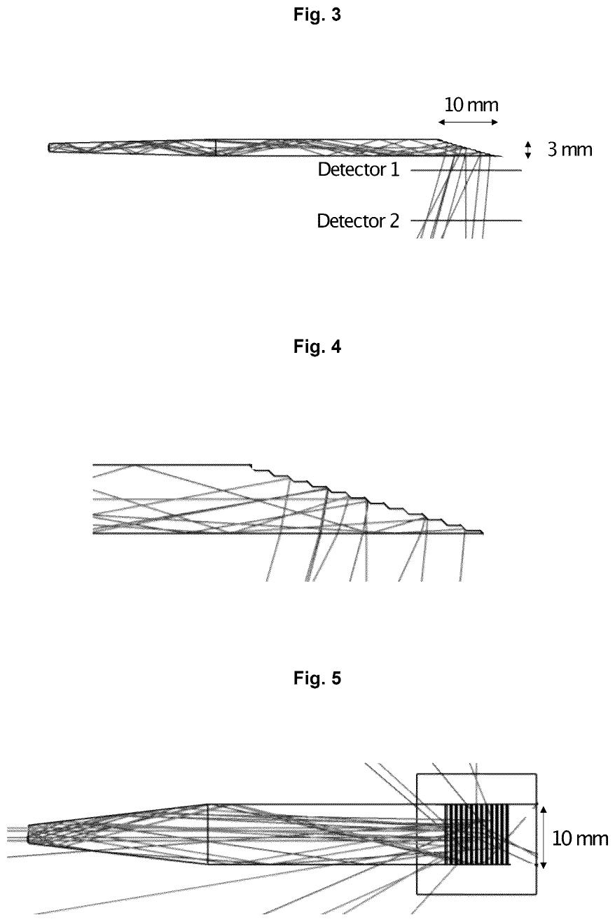

FIGS. 3-5 show a simulative test arrangement with beam paths of light from a light source with a substantially Lambertian emission, which light is coupled into a light guiding element and coupled out of the light guiding element, and with two detectors located at a distance of 1 mm and 10 mm from the light exit.

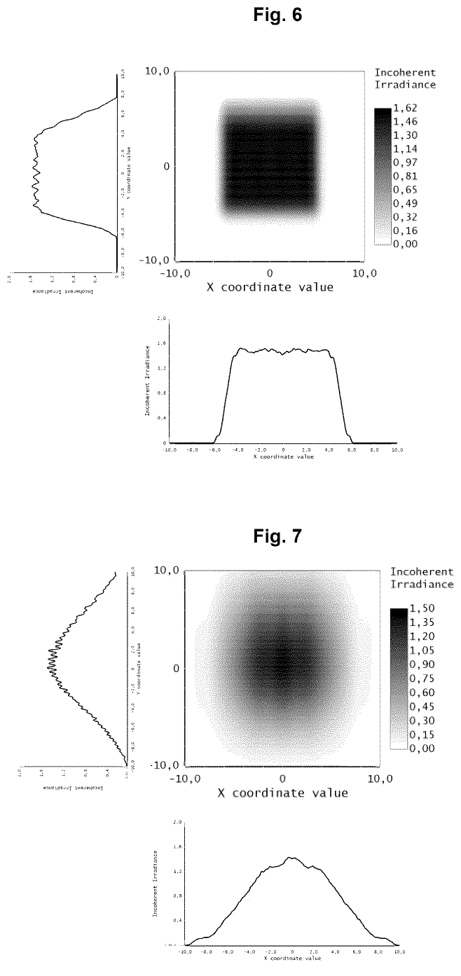

FIGS. 6-7 show the local irradiance, determined therewith, of the coupled-out light at a distance of 1 mm and 10 mm from the light exit. As can be seen, the exemplary light guiding element 20 enables an extremely homogeneous irradiance with a particularly rectangular format over an area of approx. 8 mm×8 mm at a distance of 1 mm.

In the case of the application, e.g., the curing of at least one layer of a light-curable resin or resin composite, e.g., the filling of a tooth, it is usually desirable to achieve uniform curing. Accordingly, the irradiance or the irradiation time must be configured in such a way that a desired result is even achieved at the places of lower irradiance. In other words, it is desirable that each area to be cured is irradiated with at least a defined energy. In this context, higher amounts of energy, an overexposure as it were, often lead neither to an improvement nor to a deterioration of the curing result—as long as very high amounts of energy do not lead to overheating or other damage to the material to be cured. The curing should therefore preferably be selected in terms of time and/or energy so that the area of the surface to be cured that is irradiated with the lowest intensity also receives a sufficient amount of energy. The minimum radiation intensity I_min in the working area, the area or volume to be cured, therefore preferably determines the curing time.

The working area is the product of the curing area A, e.g., a 10×10 mm\hat{ }2 square or e.g., a circle with a diameter of 10 mm, and the possible or permitted working distances when irradiating a filling. This distance range is usually 0 mm to 10 mm, but can also be higher. However, direct contact with the filling material should preferably be avoided in order to prevent the material to be cured, e.g., a filling, from adhering to the light guiding element.

The efficiency h of a light guiding element for a specific working distance is then defined as:

h=(I_min*A/E), where

I_min: Minimum radiation intensity on the curing surface in the relevant wavelength range,
A: Curing surface,
E: Power radiated into the light guiding element in the relevant wavelength range.

In the ideal case, when 100% of the power radiated-in is radiated completely homogeneously and exclusively into the curing area, this efficiency h is 1.

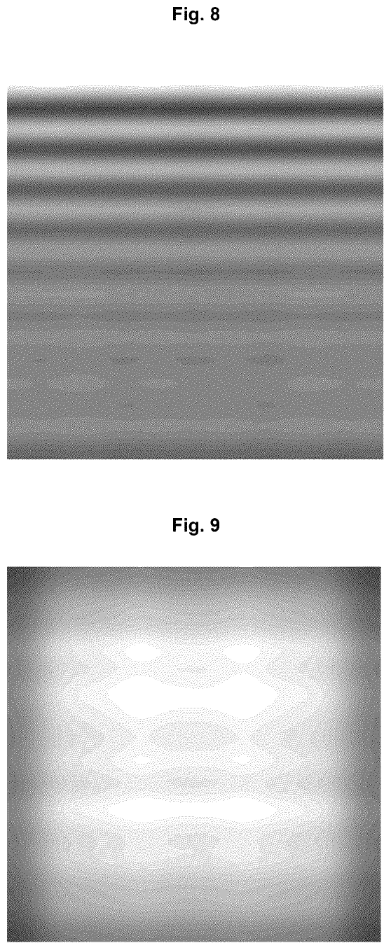

Depending on the working distance, different phenomena and their combination can influence this efficiency due to the design of the base body, the light input coupling or light source and the distal end side or the end faces and intermediate surfaces: In particular, at a small distance, the structure of the distal end face can be imaged onto the curing area and, in particular, the intermediate areas can determine the area of minimum radiation intensity. This can be seen in FIG. 8 as a striped pattern. At greater working distance, on the other hand, the divergence of the radiation emitted at the distal end comes to the fore, so that there are often areas of minimal intensity in the edge areas and/or corners. This can be seen in FIG. 9 as a vignetting pattern. FIGS. 8 and 9 show the irradiance after smoothing by means of a Gaussian curve, wherein the Gaussian curve shows a drop to 1/e² at a diameter of 1 mm. Smoothing by means of the Gaussian curve takes into account light scattering in a translucent material to be cured.

FIG. 8 shows the limitation of the minimum intensity at the distal end due to the intermediate areas at a distance of 0 mm from the working surface for a base body with 10 end sides, illuminated proximally with Lambertian emission. FIG. 9 shows the limitation due to the divergence of the light at a distance of 10 mm from the working surface. In particular, the target area in these examples has an area of 10 mm². Furthermore, an illumination with two LEDs with Lambertian emission can be provided, wherein an illumination distance in the range of 1 to 4 mm can be provided, for example. The thickness d1 of the base body is in particular 5 mm.

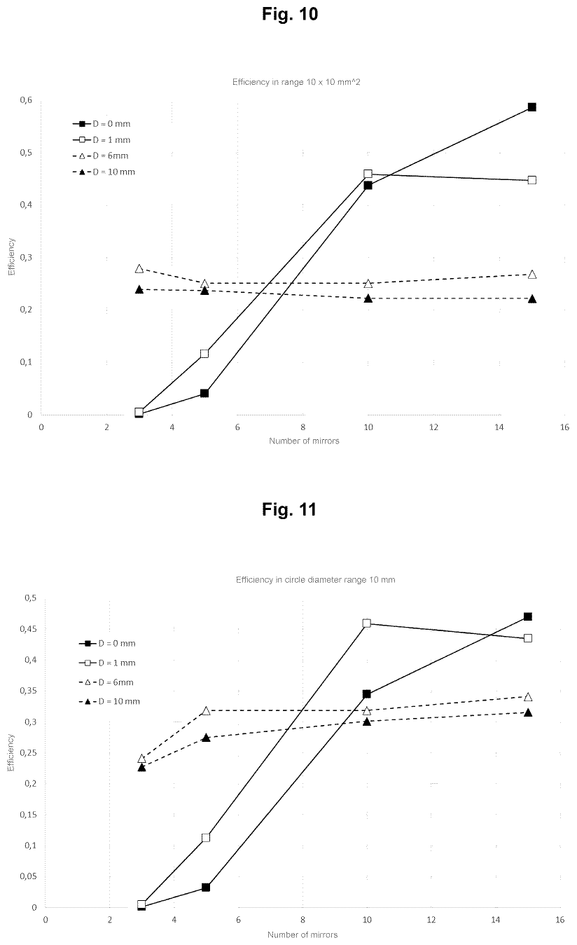

FIGS. 10 and 11 show the efficiency h=(I_min*A/E) plotted against the number of end faces for a family of working distances in the case of a square curing area (FIG. 10) and in a circle diameter (FIG. 11) respectively. By way of example, light guiding bodies according to the invention can thus be provided which, in particular when illuminated by two light sources with Lambertian emission at an illumination distance e.g., in the range of 1 to 4 mm, have an efficiency h of >0.05, preferably >0.25, most preferably >0.30, in any case<1.00. Thus, at a working distance of 0 mm, an efficiency of approx. 0.33 on a 10×10 mm² surface or 0.25 on a circle with a diameter of 10 mm arises for a light guiding element with a rectangular base body with a height of 3 mm and with 10 end faces. At a distance of 10 mm, the corresponding values are approx. 0.2 and 0.3. If the base body has a thickness d1 of 5 mm and has 10 end faces, the corresponding values at a distance of 0 mm are approx. 0.44 with regard to the 10×10 mm² surface or 0.34 with regard to a circle with a diameter of 10 mm, and approx. 0.22 and 0.3, respectively, at a distance of 10 mm. In terms of efficiency on a surface of 10×10 mm², an efficiency of approx. 0.58 at 0 mm spacing and 0.22 at 10 mm spacing can be achieved with the latter base body with a higher number of, for example, 15 end faces. With the number of end faces equalling 5, the corresponding values are approx. 0.05 and 0.24 respectively.

Particularly on the basis of these findings, it may be particularly preferred that a number of end faces is provided, possibly per longitudinal dimension, which lies in the ranges described above. For example, a number of end faces in the range of 4 to 18 or in the range of 5 to 16, in particular arranged alternately with intermediate surfaces, can also be provided.

Generally, it may be provided that the plurality of end faces are each equally aligned (have the same normal vector) and/or are of equal size and/or are evenly distributed along the longitudinal extent. With 10 end faces and a thickness d1 of 3 mm, each end face can be 0.3 mm thick, for example. Furthermore, each end face, for example, can also be 0.3 mm long (extent along the longitudinal dimension). In this example, 9 intermediate surfaces are then provided in particular, each of which extends over a length of (10 mm-3 mm)/9=0.78 mm, for example.

In addition to a very flat light guiding element, which is particularly suitable for light curing in areas which are difficult to access, the invention thus enables an optimized efficiency and ensures good adaptation of the emission characteristic to the shape of the area to be cured, e.g., a tooth.

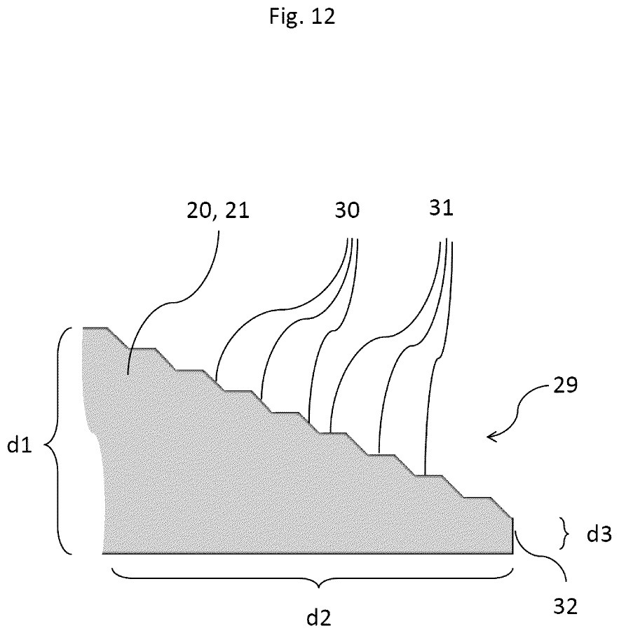

FIG. 12 shows an embodiment of a monolithic light guiding element 20 which has a terminal edge 32. In this case, the terminal edge extends substantially perpendicular to the longitudinal extent of the light guiding element, but could also run within an angular range of e.g., +−25° with respect thereto or could also be rounded. In any case, the terminal edge 32 runs steeper than the end faces 30, and so at the distal end of the light guiding body the angle at the transition to the light emission becomes more obtuse. This can avoid a sharp termination and a risk of injury, especially in medical applications.

What is claimed is:

1. A light application device for light curing of liquid materials, comprising:
a handpiece with a housing;
a light source arranged in the housing and configured to emit light from the handpiece;
a light guiding element mounted to the handpiece and has a light guiding body comprising a solid body, a light entrance for coupling light into the light guiding body, and a light exit for coupling light out of the light guiding body,
wherein the light guiding element has a longitudinal extent and defines a first optical axis for light coupled into the light guiding body, wherein the first optical axis runs along the longitudinal extent, and wherein the light exit defines a second optical axis for light coupled out of the light guiding body, wherein the second optical axis runs transversely to the first optical axis,
wherein the light guiding element has, at a distal end of the longitudinal extent, a distal end side at which the light coupled into the light guiding body can be deflected for coupling out in such a way that the light exit is formed by a region of a lateral surface of the light guiding element, and
wherein the distal end side has a plurality of end faces for deflecting the light, wherein the plurality of end faces each extend transversely to the first optical axis and transversely to the second optical axis and are connected to one another via intermediate surfaces.

2. The device of claim 1, wherein the light guiding element is detachably mounted to the handpiece.

3. The device of claim 1, further comprising a feature selected from a group consisting of: the plurality of end faces are connected to one another by the intermediate surfaces offset along the longitudinal extent of the light guiding element; the light exit has a dimension along the longitudinal extent in a range of 2 mm to 20 mm; the light exit has a dimension along the longitudinal extent in a range of 5 mm to 15 mm; the light exit has a dimension along the longitudinal extent in a range of 3 mm to 8 mm; the light guiding element has a thickness perpendicular to the light exit that is in a range of 1 mm to 15 mm; the light guiding element has a thickness perpendicular to the light exit that is in a range of 2 mm to 10 mm; the light guiding element has a thickness perpendicular to the light exit that is in a range of 3 mm to 8 mm; the light exit has a dimension along the longitudinal extent that is greater than a thickness of the light guiding element perpendicular to the light exit by a factor of at least 1.5; the light exit has a dimension along the longitudinal extent that is greater than a thickness of the light guiding element perpendicular to the light exit by a factor of at least 2; the light exit has a dimension along the longitudinal extent that is greater than a thickness of the light guiding element perpendicular to the light exit by a factor of at least 3; and combinations thereof.

4. The device of claim 1, wherein the distal end face has a terminal surface at an outermost end, wherein the terminal surface has a feature selected from a group consisting of: forms an obtuse termination of the light guiding element and extends in such a way that acute angles are avoided at the outermost end; extends in such a way that a normal vector of the terminal surface forms a larger angle with the first optical axis than an angle between the normal vector of an end face and the first optical axis; has a thickness fraction ranging from 3% to 30% of a thickness of the light guiding element; and combinations thereof.

5. The device of claim 1, further comprising a feature selected from a group consisting of: at least some of the plurality of end faces having a planar shape; at least some of the plurality of end faces having a common orientation to one another; at least some of the intermediate surfaces having a planar shape; at least some of the intermediate surfaces having a common orientation to one another; the intermediate surfaces extend in such a way that a normal vector to the intermediate surface forms an angle with the first optical axis that is smaller than an angle between the normal vector of an end face and the first optical axis; the intermediate surfaces extend in such a way that a normal vector to the intermediate surface forms an angle with the first optical axis which is between 70 and 110 degrees; the intermediate surfaces extend in such a way that a normal vector to the intermediate surface forms an angle with the first optical axis which is between 80 and 100 degrees; the intermediate surfaces extend in such a way that a normal vector to the intermediate surface forms an angle with the first optical axis which is between 85 and 95 degrees; and combinations thereof.

6. The device of claim 1, further comprising a feature selected from a group consisting of: the plurality of end faces extending in such a way that a normal vector to the end face forms an angle with the first and/or second optical axis which is between 157.5 and 112.5 degrees; the plurality of end faces extending in such a way that a normal vector to the end face forms an angle with the first and/or second optical axis which is between 145 and 125 degrees; the plurality of end faces extending in such a way that a normal vector to the end face forms an angle with the first and/or second optical axis which is between 140 and 130 degrees; the plurality of end faces extending in such a way that a normal vector to the end face forms an angle with the first and/or second optical axis which is between 137.5 and 132.5 degrees; the second optical axis running at an angle to the first optical axis that is between 45 and 135 degrees; the second optical axis running at an angle to the first optical axis that is between 70 and 110 degrees; the second optical axis running at an angle to the first optical axis that is between 80 and 100 degrees; the second optical axis running at an angle to the first optical axis that is between 85 and 95 degrees; and combinations thereof.

7. The device of claim 1, wherein the plurality of end faces comprises between 5 to 20 end faces and/or wherein the plurality of end faces comprises a number of faces per millimetre along the longitudinal extent in the range of from 0.5 to 2.

8. The device of claim 1, wherein the light guiding element comprises a reflector positioned and configured to couple out light from the light guiding body.

9. The device of claim 8, wherein the reflector is a mirror or interference mirror.

10. The device of claim 8, wherein the reflector has a reflectivity for light with a wavelength between 380 and 500 nanometres of more than 90 percent.

11. The device of claim 1, wherein the solid body is a material selected from a group consisting of a homogeneous material; an isotropic material; and a monolithic material; glass; pressed glass; borosilicate glass; optical crown glass; plastic; injection moulded plastic; polycarbonate (PC); polymethylmethacrylate (PMMA); and cycloolefin copolymers (COC).

12. The device of claim 1, wherein the plurality of end faces and/or the intermediate surfaces comprise laser cut surfaces.

13. The device of claim 1, wherein the light guiding element further comprises a cladding partially or completely enclosing the light guiding body, wherein the cladding has a refractive index that is less than one or less than the refractive index of the light guiding body, wherein the refractive index of the light guiding body and the refractive index of the cladding have a difference of less than or equal to 0.16, and wherein the cladding has a thickness that is less than or equal to 100 μm.

14. The device of claim 1, wherein the housing comprises a mounting device and the light guiding element comprises a mounting area for mounting the light guiding element to the housing in such a way that light emitted by the light source is coupled into the light guiding body through the light entrance and is coupled out of the light guiding body outside the housing of the handpiece through the light exit.

15. The device of claim 1, wherein the light guiding element is formed in the shape of a rod with a rod axis that runs along the longitudinal extent, wherein the second optical axis runs transversely to the longitudinal extent, and wherein the light guiding element has a proximal end face at a proximal end of the longitudinal extent, the proximal end face forming the light entrance.

16. The device of claim 1, wherein the longitudinal extent is between 1 and 30 centimetres, and wherein the light guiding element has a cross section along the longitudinal extent with an area between 0.1 and 3 square centimetres.

17. The device of claim 1, wherein the light guiding element has a variable cross section along the longitudinal extent.

18. The device of claim 1, further comprising a voltage source arranged in the housing, the voltage source being configured to provide power to the light source.

19. A method for producing a light guiding element, comprising:
providing a base body with a longitudinal extent made of a pressed glass or injection moulded plastic; and
processing distal ends of the base body to define a plurality of end faces that are connected to one another via intermediate surfaces.

20. The method of claim 19, wherein the processing step comprises:
laser cutting the distal ends of the base body so that a first cut surface is formed at the distal end along a first direction running obliquely to the longitudinal extent to form the plurality of end faces; and
laser cutting a second cut surface along a second direction running more parallel to the longitudinal extent than the first direction to form the intermediate surfaces.
